(19) United States
(12) Patent Application Publication
(10) Pub. No.: US 2013/0166991 A1
(43) Pub. Date: Jun. 27, 2013

(54) Non-Volatile Semiconductor Memory Device Using Mats with Error Detection and Correction and Methods of Managing the Same

(71) Applicant: Samsung Electronics Co., Ltd., Suwon-si (KR)

(72) Inventor: Toshiki Shimada, Kanagawa (JP)

(73) Assignee: Samsung Electronics Co., Ltd., Suwon-si (KR)

(21) Appl. No.: 13/714,729

(22) Filed: Dec. 14, 2012

(30) Foreign Application Priority Data
Dec. 16, 2011 (JP) 2011-275699

(51) Int. Cl. G06F 11/10; G06F 12/06; G06F 11/00

(52) U.S. Cl. CPC G06F 11/10; G06F 11/006; G06F 12/0646
USPC 714/764; 714/800; 711/170

(57) ABSTRACT

A non-volatile semiconductor memory device can include a RAID controller configured to, upon data recording, distributively record a plurality of pieces of division data obtained by dividing the corresponding data and parity data generated from the division data in respective non-faulty blocks of a plurality of memory mats with reference to a bad block table, upon data reading, read a plurality of pieces of division data and parity data corresponding to designated data from respective blocks of the plurality of memory mats, and when an error occurs, recover data of a memory mat in which the error has occurred using data of another memory mat, store the recovered data in a block of the same memory mat in which the error has occurred other than a previous block, and store data representing the block in which the error has occurred in the bad block table.

### CROSS-REFERENCE TO RELATED APPLICATION

This application claims priority under 35 U.S.C. §119 to Japanese Patent Application No. 10-2011-275699 filed on Dec. 16, 2011, the disclosure of which is hereby incorporated by reference in its entirety.

### BACKGROUND

1. Field

Embodiments of the inventive concept relate to a non-volatile semiconductor memory device and a method of managing the same.

2. Description of Related Art

In general, a plurality of NAND flash memory cells used in a semiconductor drive device are divided into pages that include several predetermined memory cells and serve as units for data program (write) and read, and blocks that include several predetermined pages and serve as units for erasing data. Also, a memory mat includes several predetermined blocks that share a word line decoder, and so on.

In some conventional semiconductor drive devices, a page of parity may be generated for several predetermined pages of data, and recorded in several following predetermined pages. When a read error occurs in a page, data may be recovered using data of another page and parity data. Also, data that fails to be read becomes invalid, and recovered data is recorded in another page through a recovery process.

### SUMMARY

Embodiments of the inventive concept provide a non-volatile semiconductor memory device and a method of managing the same that are capable of solving the aforementioned problem.

The technical objectives of the inventive concept are not limited to the above disclosure; other objectives may become apparent to those of ordinary skill in the art based on the following descriptions.

In accordance with an aspect of the inventive concept, a non-volatile semiconductor memory device includes: a plurality of memory mats having several blocks including several non-volatile memory cells; a bad block table configured to store data representing a faulty block included in the plurality of blocks in the respective memory mats; and a controller circuit configured to, upon data writing, distributively write a plurality of pieces of divided data obtained by dividing the corresponding data and parity data generated from the divided data to respective non-faulty blocks of the plurality of memory mats with reference to the bad block table, upon data reading, read a plurality of pieces of division data and parity data corresponding to designated data from respective blocks of the plurality of memory mats, and check whether or not there is an error in the read data, and when it is checked that there is an error, recover data of a memory mat in which the error has occurred using data of another memory mat, store the recovered data in a block of the same memory mat in which the error has occurred other than a previous block, and store data representing the block in which the error has occurred in the bad block table.

### BRIEF DESCRIPTION OF THE DRAWINGS

FIG. 1 is a block diagram showing a non-volatile semiconductor memory device in accordance with an embodiment of the inventive concept;

FIG. 2 is an explanatory diagram illustrating memory mats of FIG. 1;

FIG. 3 is an explanatory diagram illustrating a bad block table and a valid block table;

FIG. 4 is another explanatory diagram illustrating an example of the configuration of the bad block table and the valid block table;

FIG. 5 is a flowchart illustrating an example of programming operations of a non-volatile semiconductor memory device; and

FIG. 6 is a flowchart illustrating read operations of the non-volatile semiconductor memory device.

### DETAILED DESCRIPTION OF THE EMBODIMENTS ACCORDING TO THE INVENTIVE CONCEPT

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor circuit of a general purpose computer, special purpose computer, or other programmable data processing apparatus to produce a machine, such that the instructions, which execute via the processor circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

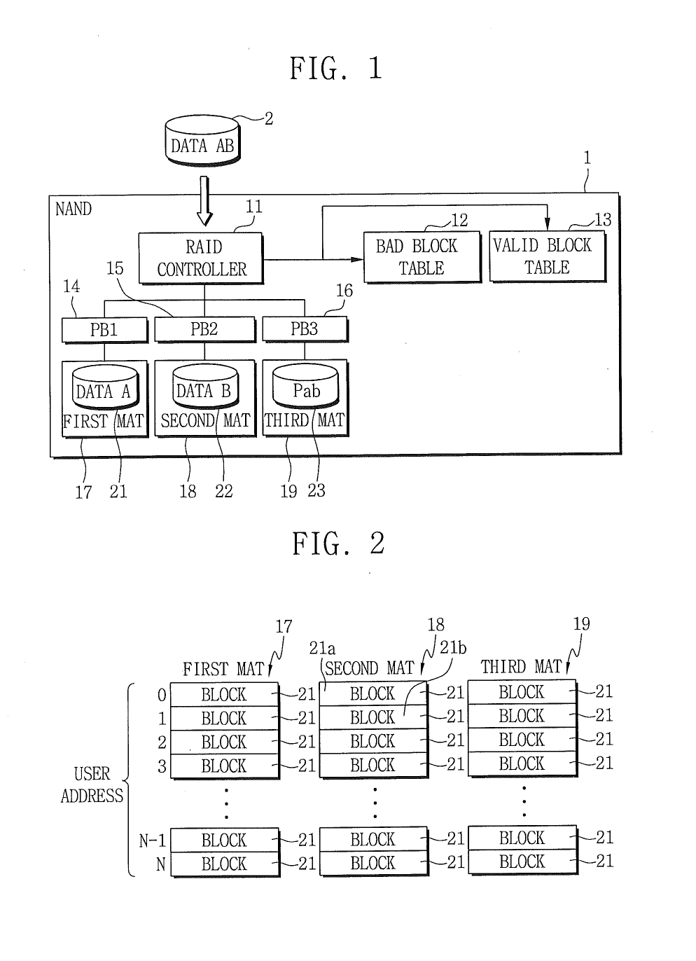

Hereinafter, embodiments of the inventive concept will be described with reference to the drawings. FIG. 1 is a block diagram illustrating a non-volatile semiconductor memory device 1 as an embodiment of the inventive concept.

The non-volatile semiconductor memory device 1 can be, for example, a single chip NAND flash memory device. However, other configurations of the non-volatile semiconductor memory device are also possible, and are not limited to those shown. The non-volatile semiconductor memory device 1 can include a plurality of input/output (I/O) terminals, a write enable terminal, a read enable terminal, a ready/busy terminal, a power terminal, a ground terminal, etc. that are terminals connected with external devices as I/O terminals of addresses, data or commands.

Also, the non-volatile semiconductor memory device 1 includes a power supply circuit, a variety of registers, an address decoder circuit, such as a word line decoder, a timing control circuit, etc. therein.

The non-volatile semiconductor memory device 1 can include a wear leveling function to equalize recording frequency according to usage frequency of the non-volatile semiconductor memory device.

The non-volatile semiconductor memory device 1 in accordance with this embodiment can include a redundant array of inexpensive disk (RAID) controller 11, a bad block table 12, a valid block table 13, a first page buffer 14, a second page buffer 15, a third page buffer 16, a first memory mat 17, a second memory mat 18, and a third memory mat 19. It will be understood that the term “mat” can include structures and functions that represent a memory map of portions of the non-volatile semiconductor memory device 1. In some embodiments according to the inventive concept, the controller 11 is provided by a controller circuit, a processor circuit and/or other specialized circuitry or combinations of hardware and software.

Each of the first memory mat 17, the second memory mat 18 and the third memory mat 19 is a memory cell array having one group of several blocks including several NAND-type non-volatile memory cells. In this example, the first memory mat 17, the second memory mat 18 and the third memory mat 19 include registers, sense amplifiers, selection gates, or so on. Also, each of the first memory mat 17, the second memory mat 18 and the third memory mat 19 includes several predetermined blocks that share a word line decoder and so on. The several NAND-type non-volatile memory cells are divided into pages that include a predetermined number of NAND-type non-volatile memory cells and serve as units for data program (write) and read, and blocks that include a predetermined number of pages and serve as units for data erasure.

The first page buffer 14, the second page buffer 15 and the third page buffer 16 are memory circuits that are used for storing data that will be recorded in or has been read from the first memory mat 17, the second memory mat 18 and the third memory mat 19, respectively.

The bad block table 12 is a non-volatile memory circuit that stores data representing, in every mat, a faulty block among the several blocks of the first memory mat 17, the second memory mat 18 and the third memory mat 19.

The valid block table 13 is a non-volatile memory circuit that stores data representing valid blocks among the plurality of blocks of the first memory mat 17, the second memory mat 18 and the third memory mat 19 as data that can be referred to (i.e., inquired about) from the outside. When external data is recorded in the non-volatile semiconductor memory device 1 in accordance with this embodiment, it is programmed to blocks represented by the data stored in the valid block table 13 (i.e., the external data is programmed to blocks that are indicated by the valid block table as being functional and available).

The RAID controller 11 is a circuit that controls data division, parity generation, and data recovery performed for writing (programming) and reading data input from the outside in and from non-volatile memory cells. The RAID controller 11 selects a block in which recording will be performed with reference to the bad block table 12, and registers a block in the bad block table 12 when an error occurs in the block. Also, when an error occurs, the RAID controller 11 replaces a block in which the error has occurred with a block in which no error has occurred, and removes the block used for replacement from the valid block table 13. In other words, the block having the detected error is removed from the valid block table 13 and is entered in the bad block table 12. At this time, the replacement-target block is set in the same memory mat 17, 18 or 19 as the block in which the error has occurred. For example, when a fault occurs in a block of the first memory mat 17, another block in the first memory mat 17 becomes the replacement target.

After the replacement process, the RAID controller 11 replaces an address of the faulty block before replacement with an address of the block after replacement. In other words, it is possible to access the address after replacement from the outside by designating the address of the block before the error has occurred.

A replacement method is not particularly limited. For example, two or more blocks in the same memory mat may be set as one set in advance to perform replacement between blocks in the set, or all blocks in the same memory mat may be set as one set to perform replacement on a one-to-one basis. A replacement-target block may be set not to be accessed by a user before it is set as a replacement-target block, or several blocks to be replacement targets may be prepared to be accessible so that a block having an address not in use among the blocks may be selected as a replacement target. In other words, in some embodiments according to the inventive concept, some blocks may be pre-allocated for use a replacement blocks to replace blocks discovered to be bad. Accordingly, the pre-allocated blocks may be designated as unavailable to users, as those blocks should be available when needed.

Unless clearly specified below, a recovery process (or recovery) denotes a process of generating the original data by integrating divided data without correcting an error in the divided data, or a process of correcting an error in divided data and parity data (or a process of generating the original data by integrating data after correcting an error).

In other words, upon data writing, the RAID controller 11 divides data input from the outside, generates parity data on the basis of the divided data, stores the divided data and the parity data in the first page buffer 14, the second page buffer 15 and the third page buffer 16 respectively corresponding to the first memory mat 17, the second memory mat 18 and the third memory mat 19, and controls writing (programming) in non-volatile memory cells. At this time, the RAID controller 11 distributively records the divided data and the parity data in respective blocks other than a faulty block in the first memory mat 17, the second memory mat 18 and the third memory mat 19 with reference to the bad block table 12. Specifically, the divided data and the parity data is distributed to the respective blocks of the different first to third memory mats 17 to 19. In this embodiment, since the number of memory mats is three, input data is divided into two pieces, and one piece of parity data is generated by taking a bitwise exclusive OR of the two pieces of division data. Then, the two pieces of division data and the one piece of parity data are distributively recorded in respective blocks of the first to third memory mats 17 to 19. For example, when input data 2 (Data AB including data “A” and data “B”) is recorded as shown in FIG. 1, data 21 (Data A including data “A”) is recorded in a predetermined block of the first memory mat 17, data 22 (Data B including data “B”) is recorded in a predetermined block of the second memory mat 18, and data 23 (parity data Pab generated on the basis of data “A” and data “B”) is recorded in a predetermined block of the third memory mat 19.

Upon data reading, the RAID controller 11 reads divided data and parity data corresponding to a designated address from the respective first to third memory mats 17 to 19 through the respective first to third page buffers 14 to 16 in block units (or in units of a predetermined number of bits in a block), checks parity, and performs a data recovery process.

The RAID controller 11 senses whether there is a faulty block through a parity check upon data recovery, and automatically updates the bad block table 12 when a faulty block is sensed. Also, the RAID controller 11 sets a block that replaces the faulty block, and updates the valid block table 13 to set a set of blocks and prevent access to the block thereafter, that is, to ensure new reliability. A user who writes data to or reads data from the non-volatile semiconductor memory device 1 (here, the user denotes, for example, a driver software or a kernel of an operating system run by a computer, and so on) may record the data in a non-faulty block by monitoring the bad block table 12 or the valid block table 13.

As described above, upon data writing, the RAID controller 11 distributively records a plurality of pieces of divided data obtained by dividing the corresponding data and parity data, generated from the division data, in respective blocks (other than a faulty block) in the respective first to third memory mats 17, 18 and 19 with reference to the bad block table 12. Upon data reading, the RAID controller 11 reads a plurality of pieces of division data and parity data corresponding to designated data from respective blocks of the first to third memory mats 17 to 19, checks whether or not there is an error in the read data, and recovers data of one memory mat in which an error has occurred among the first to third memory mats 17 to 19 using data of another memory mat when it is checked that there is an error in the read data. Also, the RAID controller 11 controls the recovered data to be stored in another block of the same memory mat in which the error has occurred, and data representing a block in which the error has occurred to be stored in the bad block table 12. When storing the data representing the block in which the error has occurred (i.e., the bad block) in the bad block table 12, the RAID controller 11 removes data representing the bad block from the valid block table 13.

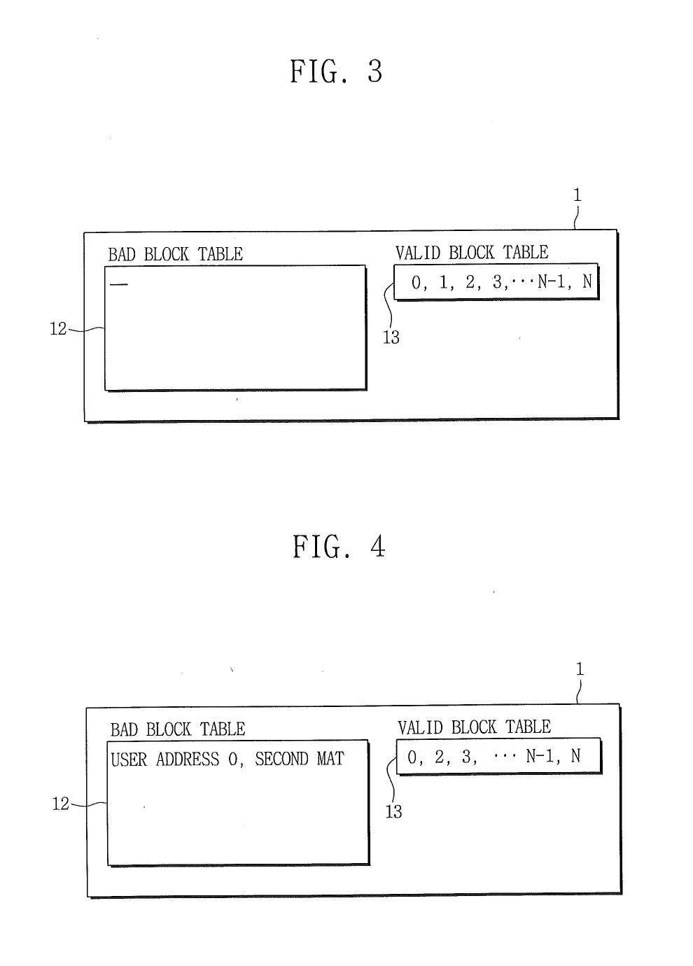

Next, an example of respective blocks in the first to third memory mats 17 to 19 of FIG. 1, and an example of the bad block table 12 and the valid block table 13 will be described with reference to FIGS. 2 to 4. In an example shown in FIG. 2, each of the first to third memory mats 17 to 19 has N+1 blocks 21 to which user addresses 0 to N are assigned. A user address is used for designating a block to which the user will perform data reading and writing in block units. When the respective blocks in the first to third memory mats 17 to 19 are configured as shown in FIG. 2, and all blocks are valid (i.e., there is no faulty block), as shown in FIG. 3, no block is registered in the bad block table 12, and all the user addresses 0 to N are registered in the valid block table 13. Initial values of the bad block table 12 and the valid block table 13 may be registered, for example, in a manufacturing or shipping step in a factory.

When a data read error occurs in the block 21 having the user address 0 (i.e., a block 21a) of the second memory mat 18 of FIG. 2, information that represents the user address 0 and the second memory mat 18 as one group is registered in the bad block table 12 as shown in FIG. 4. Also, from the valid block table 13, a user address of a block that is selected as a replacement target of the block 21a having the user address 0 in the second memory mat 18 is removed. For example, when a fault occurs in the block 21a having the user address 0 of the second memory mat 18 (i.e., a parity error is checked), and a block 21b having the user address 1 of the second memory mat 18 is set as the replacement target block of the block 21 a having the user address 0 in the second memory mat 18, the user address 1 of the replacement target block 21b is removed from the valid block table 13. In this case, with reference to the valid block table 13, the user may be prevented from accessing the block 21b having the user address 1 upon data recording.

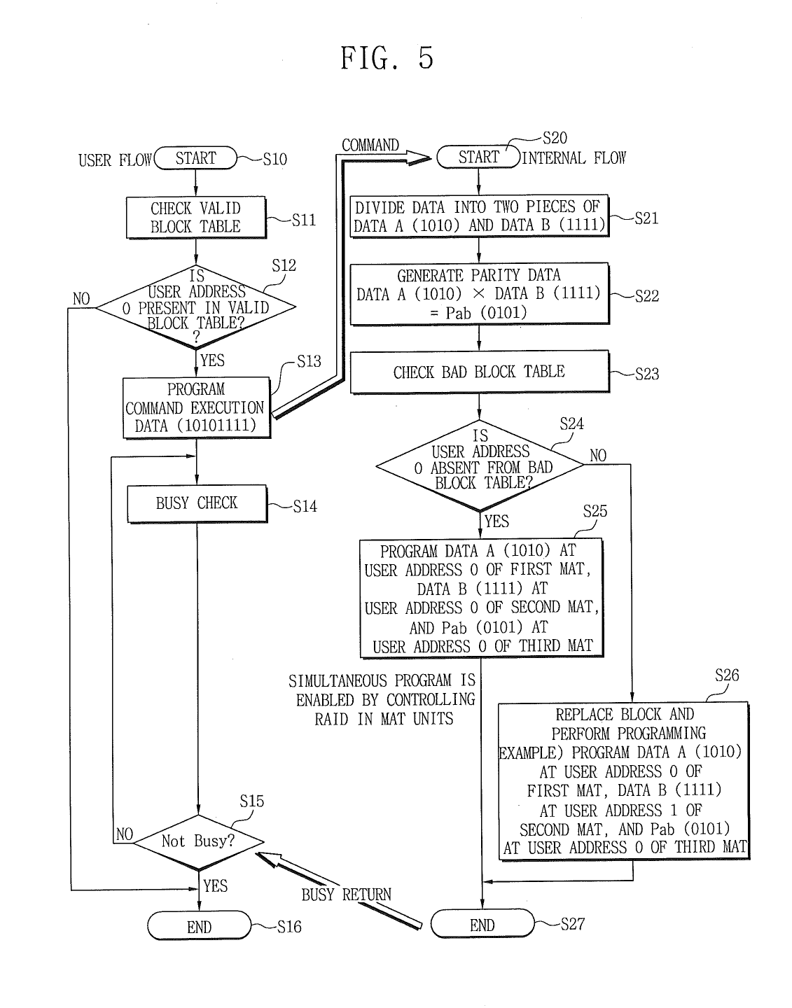

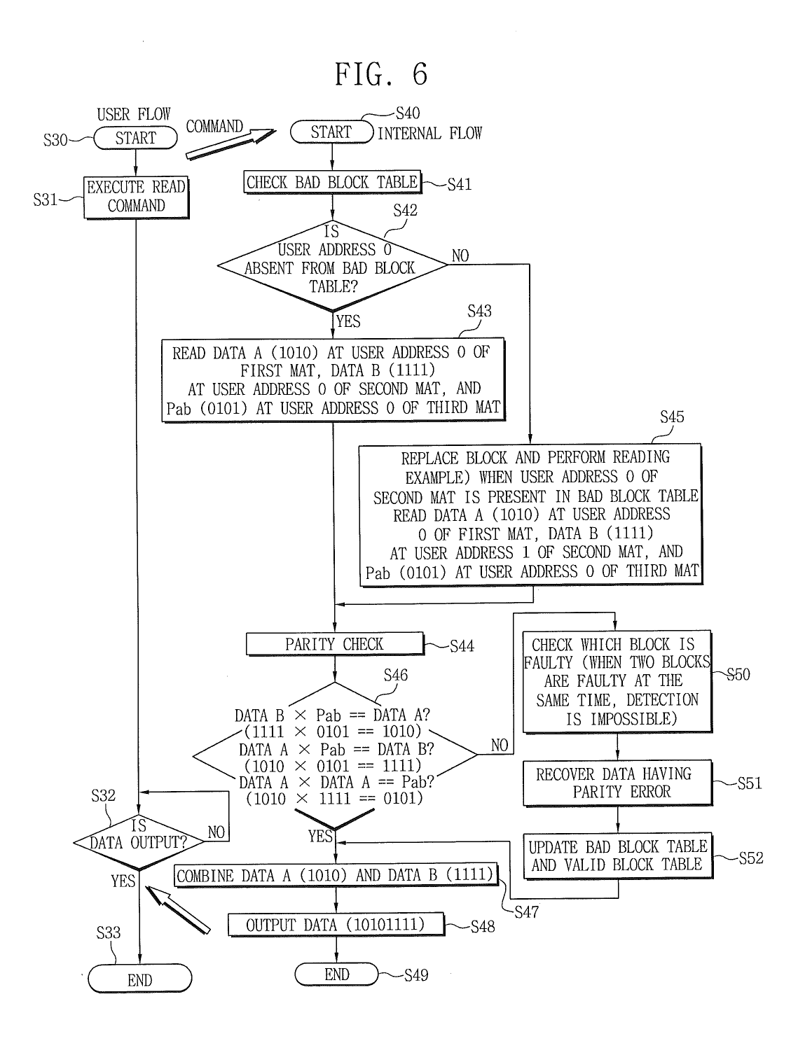

Next, with reference to FIG. 5, a data recording operation of the non-volatile semiconductor memory device 1 shown in FIG. 1 will be described. In operation examples shown in FIG. 5 and FIG. 6, it is assumed that user addresses in the same memory mat are combined as (0, 1), (2, 3), . . . , and (N−1, N) to perform block replacement. Also, it is assumed that a user can only access even addresses. For example, when a block having the address 0 of the first memory mat 17 is faulty, the block is replaced by a block having the address 1 of the first memory mat 17.

However, even after the replacement, the user can access the block having the user address 1 of the first memory mat 17 by accessing the user address 0.

In FIG. 5, steps S10 to S16 correspond to a process of a user side, and steps S20 to S27 correspond to a process in the non-volatile semiconductor device 1. A flowchart of FIG. 5 illustrates a case in which the user records 8-bit data (10101111) in a block 21 having the user address 0.

First, the user issues a predetermined command to check the valid block table 13 to the non-volatile semiconductor memory device 1, and receives data representing content of the valid block table 13 from the non-volatile semiconductor memory device 1 (step S11). Here, a command to inquire whether or not the user address 0 is included in the valid block table 13 is assumed to be issued by the user. Also, it is assumed that the RAID controller 11 in the non-volatile semiconductor memory device 1 checks whether the user address 0 is included in the valid block table 13 as shown in FIG. 3 with reference to the valid block table 13, and a response to the inquiry is made for the user by the non-volatile semiconductor memory device 1.

In this case, the user checks whether or not the user address 0 is included in the valid block table 13 according to the response from the non-volatile semiconductor memory device 1 (step S12), and determines that the user address 0 is present in the valid block table 13 (“Yes” in step S12). Next, the user issues a write command (program command) to record the data (10101111) to a block 21 having the user address 0 (step S13). After that, in the user side, a process of checking a state of the ready/busy terminal in step S14, and a process of determining whether or not the ready/busy terminal has been placed in the ready state in step 15 are repeatedly performed until the ready/busy terminal of the non-volatile semiconductor memory device 1 is placed in a ready state.

In the non-volatile semiconductor memory device 1 that receives the write command issued by the user in step S13, the ready/busy terminal is placed in a busy state, and then the RAID controller 11 divides the input data (10101111) into two pieces of data, that is, Data A (1010) and Data B (1111) (step S21). Subsequently, parity data Pab (0101) is generated by taking an exclusive OR of Data A (1010) and Data B (1111) divided by the RAID controller 11 (step S22). Then, the RAID controller 11 refers to the bad block table 12 (step S23).

When the result of referring to the bad block table 12 in step S23 is that the user address 0 is not present in the bad block table 12 as shown in FIG. 3 (“Yes” in step S24), the RAID controller 11 performs a process of recording Data A (1010) in a block 21 having the user address 0 of the first memory mat 17, Data B (1111) in the block 21 (block 21a) having the user address 0 of the second memory mat 18, and the data Pab (0101) in a block 21 having the user address 0 of the third memory mat 19 (step S25). When the recording is finished, the ready/busy terminal of the non-volatile semiconductor memory device 1 is placed in the ready state, and the process of the command ends (step S27). In this embodiment, a RAID system that distributively stores data using the first to third memory mats 17 to 19 is constructed, and thus respective pieces of data can be written in the first to third memory mats 17 to 19 at the same time.

Meanwhile, when the result of referring to the bad block table 12 in step S23 is that the user address 0 is present in the bad block table 12 as shown in FIG. 4 (“No” in step S24), the RAID controller 11 sets a replacing block according to content of the bad block table 12 (in this example, the user address 1 of the second memory mat 18 is set to replace the user address 0), and performs a process of writing Data A (1010) in the block 21 having the user address 0 of the first memory mat 17, Data B (1111) in the block 21 (block 21b) having the user address 1 of the second memory mat 18, and the data Pab (0101) in the block 21 having the user address 0 of the third memory mat 19 (step S26). When the writing is finished, the ready/busy terminal of the non-volatile semiconductor memory device 1 is placed in the ready state, and the process of the command ends (step S27).

In this way, the data (10101111) indicated by the user is written in the non-volatile semiconductor memory device 1.

Next, with reference to FIG. 6, a data read operation of the non-volatile semiconductor memory device 1 shown in FIG. 1 will be described. In FIG. 6, steps S30 to S33 correspond to a process of a user side, and steps S40 to S52 correspond to a process in the non-volatile semiconductor device 1. A flowchart of FIG. 6 illustrates a case in which the user reads the data (10101111) recorded in the operation example of FIG. 5 from the blocks 21 having the user address 0.

First, the user executes a read command for the blocks 21 having the user address 0 (step S31). After that, on the user side, a process of checking whether or not data is output is repeatedly performed in step S32 until data is output from the non-volatile semiconductor memory device 1,

Meanwhile, in the non-volatile semiconductor memory device 1 that receives the read command issued by the user in step S31, the bad block table 12 is checked by the RAID controller 11 (step S41). When the result of referring to the bad block table 12 in step S41 is that the user address 0 is not present in the bad block table 12 as shown in FIG. 3 (“Yes” in step S42), the RAID controller 11 performs a process of reading Data A (1010) from the block 21 having the user address 0 of the first memory mat 17, Data B (1111) from the block 21 (block 21a) having the user address 0 of the second memory mat 18, and the data Pab (0101) from the block 21 having the user address 0 of the third memory mat 19 (step S43). Then, the RAID controller 11 performs a parity check using the read data (step S44).

On the other hand, when the result of referring to the bad block table 12 in step S41 is that the user address 0 is present in the bad block table 12 as shown in FIG. 4 (“No” in step S42), the RAID controller 11 sets a replacing block according to content of the bad block table 12 (in this example, the user address 1 of the second memory mat 18 is set to replace the user address 0), and performs a process of reading Data A (1010) from the block 21 having the user address 0 of the first memory mat 17, Data B (1111) from the block 21 (block 21b) having the user address 1 of the second memory mat 18, and the data Pab (0101) from the block 21 having the user address 0 of the third memory mat 19 (step S45). Then the RAID controller 11 performs a parity check using the read data (step S44).

In step S44, the RAID controller 11 takes an exclusive OR between every two pieces of data among the three pieces of data, that is, Data A, Data B and Pab, read in step S43 or step S45, and checks whether or not the result of the exclusive OR is the same as the other piece of data, thereby performing the parity check. When the result of the parity check is that all the left hand sides of three equations shown in step S46 are equal to the right hand sides (“Yes” in step S46), the RAID controller 11 combines Data A (1010) and Data B (1111) read in step S43 or step S45 (step S47). Then, the non-volatile semiconductor memory device 1 outputs Data (10101111) recovered in step S47 (step S48).

Meanwhile, when the parity check result in step S44 is that one of the left hand sides of three equations shown in step S46 is not equal to the corresponding right hand side (“No” in step S46), the RAID controller 11 checks which block is faulty (step S50), and recovers one piece of data from the other two pieces of data having no error (step S51). However, detection of a faulty block in step S50 and recovery of data in step S51 may not be performed when two (or more) blocks are faulty at the same time.

Next, the RAID controller 11 specifies and registers a memory mat of the block from which a fault has been detected in the bad block table 12, and removes the block from the valid block table 13 (step S52). After step S52, the above-described process of step S47 and step S48 is performed.

In this way, Data (10101111) stored in the blocks having the user address 0 designated by the user is read from the non-volatile semiconductor memory device 1.

The non-volatile semiconductor memory device 1 in accordance with this embodiment distributively records data and parity data thereof in a plurality of memory mats, thereby improving reliability. In other words, parity data is generated in units of numbers of memory mats. Thus, parity data generation units become irrelevant to the number of pages, and the problem of deterioration in recovery probability according to the number of pages is alleviated.

In addition, in the one non-volatile semiconductor memory device 1 in accordance with this embodiment, a RAID system can be constructed, and a faulty portion can be replaced in block units. Thus, a memory area can be automatically replaced when an error occurs, and it is necessary to replace a driver device when the RAID system is constructed using a plurality of hard disk drive devices or semiconductor drive devices. Also, since reliability of a storage area is ensured in block units and a storage area is replaced in block units, it is possible to readily improve the reliability and operating efficiency.

The non-volatile semiconductor memory device 1 can be implemented as one semiconductor chip. In this case, reliability can be improved by constructing a RAID system with hardware in the semiconductor chip, and a load of existing software used for improving the reliability is reduced.

Embodiments of the inventive concept are not limited to the description above, and can be appropriately modified by, for example, increasing the number of memory mats, causing the bad block table 12 and the valid block table to have reliability, or so on.

In a non-volatile semiconductor memory device according to embodiments of the inventive concept, division data and parity data thereof is distributively recorded in several memory mats, and thereby reliability increases. In other words, parity data is generated in units of numbers of memory mats. Thus, parity data generation units are irrelevant to the number of pages, and the aforementioned problem of variation in recovery probability related to the number of pages does not matter.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A non-volatile semiconductor memory device, comprising:
a plurality of memory mats having a plurality of blocks including a plurality of non-volatile memory cells;
a bad block table configured to store data representing a faulty block included in the plurality of blocks in the respective memory mats; and
a controller circuit configured to, upon data recording, distributively record a plurality of pieces of divided data obtained by dividing the corresponding data and parity data generated from the divided data in respective non-faulty blocks of the plurality of memory mats with reference to the bad block table, upon data reading, read a plurality of pieces of division data and parity data corresponding to designated data from respective blocks of the plurality of memory mats, and check whether or not there is an error in the read data, and when it is checked that there is an error, recover data of a memory mat in which the error has occurred using data of another memory mat, store the recovered data in a block of the same memory mat in which the error has occurred other than a previous block, and store data representing the block in which the error has occurred in the bad block table.

2. The non-volatile semiconductor memory device according to claim 1, further comprising a valid block table configured to store data representing valid blocks included in the plurality of blocks as data which can be referred to from outside,
wherein, when the controller circuit stores the data representing the block in which the error has occurred in the bad block table, the controller circuit removes the data representing the block from the valid block table.

3. The non-volatile semiconductor memory device according to claim 1, wherein three of the memory mats comprise one set,
the divided data is recorded in two of the three memory mats, and
the parity data is recorded in the third memory mat.

4. A method of managing a non-volatile semiconductor memory using a plurality of memory mats having a plurality of blocks including a plurality of non-volatile memory cells, and a bad block table storing data representing a faulty block included in the plurality of blocks in the respective memory mats, the method comprising:
upon data recording, distributively recording a plurality of pieces of division data obtained by dividing the corresponding data and parity data generated from the division data in respective non-faulty blocks of the plurality of memory mats with reference to the bad block table;
upon data reading, reading a plurality of pieces of division data and parity data corresponding to designated data from respective blocks of the plurality of memory mats, and checking whether or not there is an error in the read data; and
when it is checked that there is an error, recovering data of a memory mat in which the error has occurred using data of another memory mat, storing the recovered data in a block of the same memory mat in which the error has occurred other than a previous block, and storing data representing the block in which the error has occurred in the bad block table.

5. A method of operating a non-volatile semiconductor memory device including a plurality of memory mats each including a plurality of blocks of non-volatile memory cells, the method comprising:
replacing the blocks on a mat-by-mat basis so that a user address provided to the non-volatile semiconductor memory device during a read operation accesses a first block in a first mat and a second block in a second mat when the first or second block is listed in a bad block table.

6. The method of claim 5 wherein replacing comprises:
generating parity data on data to be programmed to different mats in the non-volatile semiconductor memory device;
programming the data to the first and second mats, respectively, in the non-volatile semiconductor memory device; and
programming the parity data to a third mat that is different from the first and second mats.

7. The method of claim 6 further comprising:
dividing the data to be programmed into first and second data;
programming the first data to the first mat; and
programming the second data to the second mat.

8. The method of claim 7 wherein:
programming the first data comprises programming the first data to a first user address in a first mat; and
programming the second data to a replacement address in the second mat upon determining that the first user address in the second mat is listed in the bad block table.

9. The method of claim 8 further comprising:
removing the replacement address from a valid block table after programming the second data to the replacement address in the second mat.

10. The method of claim 6 wherein programming the parity data comprises programming the parity data to the user address in the third mat.

11. The method of claim 8, in response to a read operation to the user address, the method further comprising:
reading the first data from the user address in the first mat;
reading the second data from the replacement address in the second mat; and
reading the parity data from the user address in the third mat to provide read parity.

12. The method of claim 11 further comprising:
generating parity using the first and second data to provide generated parity; and
comparing the generated parity to the read parity.

13. The method of claim 12 further comprising:
determining, based on comparing the generated parity to the read parity, whether a correctable error occurred during the read operation.

14. The method of claim 13 further comprising:
correcting the correctable error or indicating that an uncorrectable error occurred during the read operation.
